(19) United States
(12) Patent Application Publication
(10) Pub. No.: US 2013/0235893 A1
(43) Pub. Date: Sep. 12, 2013

(54) TRANSMISSIVE OPTICAL DEVICE, LASER CHAMBER, AMPLIFIER STAGE LASER DEVICE, OSCILLATION STAGE LASER DEVICE AND LASER APPARATUS

(71) Applicant: GIGAPHOTON INC., Tochigi (JP)

(72) Inventors: Takahito KUMAZAKI, Tochigi (JP); Osamu Wakabayashi, Tochigi (JP)

(73) Assignee: Gigaphoton Inc., Tochigi (JP)

(21) Appl. No.: 13/772,551

(22) Filed: Feb. 21, 2013

(30) Foreign Application Priority Data
Mar. 6, 2012 (JP) 2012-049121
Dec. 12, 2012 (JP) 2012-270932

(51) Int. Cl. H01S 3/034; H01S 3/22

(52) U.S. Cl. CPC H01S 3/034; H01S 3/22
USPC 372/55; 423/490

(57) ABSTRACT

A transmissive optical device includes a crystal part including a c-axis in a crystal structure. The crystal part is configured to include a surface to receive a laser beam. The c-axis is arranged to be inclined relative to an incident direction of the laser beam in a plane of incidence of the laser beam.

### CROSS-REFERENCE TO RELATED APPLICATIONS

This patent application is based upon and claims the benefit of priorities of Japanese Patent Application No. 2012-49121, filed on Mar. 6, 2012, and Japanese Patent Application No. 2012-270932, filed on Dec. 12, 2012, the entire contents of which are incorporated herein by reference.

### BACKGROUND

1. Technical Field

The disclosure relates to a transmissive optical device, a laser chamber, an amplifier stage laser device, an oscillation stage laser device and a laser apparatus.

2. Description of the Related Art

The shrinkage and higher integration of a semiconductor integrated circuit have led to demands to improve the resolving power of a semiconductor lithography apparatus (which is hereinafter called “a lithography apparatus”). Because of this, advances are being made in shortening a wavelength of light emitted from a light source for lithography. A gas laser apparatus is used as the lithography light source instead of a conventional mercury lamp. At present, as the gas laser apparatus for lithography, a KrF excimer laser apparatus that emits ultraviolet light with a wavelength of 248 nm and an ArF excimer laser apparatus that emits ultraviolet light with a wavelength of 193 nm are used.

As the next-generation lithography technology, immersion lithography is being studied that shortens an apparent wavelength of a beam from the lithography light source by filling a space between a lithographic lens on the lithography apparatus side and a wafer with a liquid and by changing a refractive index. When the immersion lithography is performed by using the ArF excimer laser apparatus as the lithography light source, the wafer is irradiated with ultraviolet light with a wavelength of 134 nm under water. This technology is called an ArF immersion lithographic exposure (or ArF immersion lithography).

A natural oscillation width of the KrF excimer laser apparatus or the ArF excimer laser apparatus is broad, which is about from 350 to 400 pm. Accordingly, if a projection lens in the lithography apparatus is used, chromatic aberration occurs and the resolving power decreases. Therefore, a spectral line width (spectral width) of a laser beam emitted from a gas laser apparatus needs to be made narrower to such a degree that the chromatic aberration can be ignored. Due to this, a line narrowing module including a line narrowing device (e.g., an etalon or a grating) is provided in a laser resonator of the gas laser apparatus, and narrowing the spectral width is implemented. The laser apparatus in which the spectral width is narrowed in this manner is called a narrow band laser apparatus.

### SUMMARY

According to one aspect of the present disclosure, there is provided a transmissive optical device that includes a crystal part including a c-axis in a crystal structure. The crystal part is configured to include a surface to receive a laser beam. The c-axis is arranged to be inclined relative to an incident direction of the laser beam in a plane of incidence of the laser beam.

According to another aspect of the present disclosure, there is provided a transmissive optical device that includes a crystal part including a c-axis in a crystal structure. The crystal part is configured to include a surface to receive a laser beam. The c-axis is arranged to be substantially parallel to the surface and substantially perpendicular to a plane of incidence of the laser beam.

### BRIEF DESCRIPTION OF THE DRAWINGS

Exemplary embodiments of the present disclosure will be described hereinafter with reference to the appended drawings.

FIG. 1 schematically shows a single crystal structure of MgF₂ crystal;

FIG. 2 schematically shows an example of a window using MgF₂ crystal;

FIG. 3 shows an example of an evaluation device that evaluates a polarization property of the window shown in FIG. 2;

FIG. 4 shows an arrangement example of the window in the evaluation device shown in FIG. 3;

FIG. 5 roughly shows a configuration of the window shown in FIG. 4 when cut by a plane of incidence of a laser beam;

FIG. 6 shows an arrangement example of a rochon prism and an energy sensor in the evaluation device shown in FIG. 3;

FIG. 7 shows a pulse energy value of a laser beam measured by the energy sensor when the rochon prism shown in FIG. 6 is rotated;

FIG. 8 roughly shows a configuration of the window shown in FIG. 3 when seen from and on a normal line;

FIG. 9 shows a polarization degree property obtained in the process of rotating the window 360 degrees in a rotational direction in the evaluation device shown in FIG. 3;

FIG. 10 shows a cross-sectional structure of a window of a first embodiment when cut by a plane including a plane of incidence of a laser beam;

FIG. 11 shows a configuration of the window shown in FIG. 10 when seen from and on a normal line;

FIG. 12 shows a cross-sectional structure of a window of a second embodiment when cut by a plane including a plane of incidence of a laser beam;

FIG. 13 shows a configuration of the window shown in FIG. 12 when seen from and on a normal line;

FIG. 14 roughly shows a configuration of an amplifier stage laser device including a stable resonator of a third embodiment;

FIG. 15 roughly shows a configuration of an amplifier stage laser device including a ring resonator of a fourth embodiment;

FIG. 16 roughly shows a configuration of a two-stage type laser apparatus of a fifth embodiment; and

FIG. 17 roughly shows a configuration of a laser apparatus including a detector and a pulse stretcher of a sixth embodiment.

### DETAILED DESCRIPTION

Hereinafter, selected embodiments of the present disclosure will be described in detail with reference to the accompanying drawings. The embodiments described hereinafter indicate examples of the present disclosure, and are not intended to limit the contents of the present disclosure. Furthermore, not all of the configurations and operations described in the respective embodiments are essential to configurations and operations in the present disclosure. Note that identical constituent elements will be given identical reference numerals and characters, and redundant descriptions thereof will be omitted.

The description is given below in line with the following contents.

Contents
1. Outline
2. Explanation of Terms
3. Transmissive Optical Device Using MgF₂ Crystal
   3.1 Structure and Physical Properties of MgF₂ Crystal
   3.2 Example of Transmissive Optical Device Using MgF₂ Crystal (Optical Window)
   3.3 Evaluation of Polarization Property of MgF₂ Window
      3.3.1 Evaluation Device
      3.3.2 Method of Measuring Polarization Degree
      3.3.3 Polarization Property Evaluation Results
4. First Example of MgF₂ Window (First Embodiment)
5. Second Example of MgF₂ Window (Second Embodiment)
6. First Example of Amplifier Stage Laser Device Including Transmissive Optical Device Configured of MgF₂ Crystal (Third Embodiment)
7. Second Example of Amplifier Stage Laser Device Including Transmissive Optical Device Configured of MgF₂ Crystal (Fourth Embodiment)
8. First Example of Laser Apparatus Including Transmissive Optical Device Configured of MgF₂ Crystal (Fifth Embodiment)
9. Second Example of Laser Apparatus Including Transmissive Optical Device Configured of MgF₂ Crystal (Sixth Embodiment)

### 1. Outline

A description is given below about an outline of embodiments.

In a conventional excimer laser, a window of a CaF₂ crystal (which is hereinafter called a “CaF₂ window”) has been used as a material of an optical window installed in a laser chamber. However, the CaF₂ window readily deteriorates under a high-power ultraviolet laser beam. The deteriorated CaF₂ window absorbs heat, and generates birefringence. This sometimes causes a change of a polarization degree, a power decline or the like in an excimer laser using the CaF₂ window.

On the other hand, MgF₂ crystal has a greater band gap than that of the CaF₂ crystal in principle. Because of this, an optical window using the MgF₂ crystal (which is hereinafter called a “MgF₂ window”) has higher resistance to an ArF laser than the CaF₂ window. Moreover, because the MgF₂ crystal has a tetragonal system crystal structure in which crystal lattice lengths of an a-axis and a c-axis are different from each other, the MgF₂ crystal has birefringence. Such MgF₂ crystal is used for the optical window of the laser chamber or other transmissive optical devices in the following embodiments.

### 2. Explanation of Terms

Next, terms used in the present disclosure are defined as follows.

“Beam path” means a path through which a laser beam passes. “Beam path length” may be the product of a distance at which light actually passes and a refractive index of a medium through which the light has passed. “Beam cross-section” may be an area in a plane perpendicular to a traveling direction of a laser beam and having a light intensity equal to or more than a certain value. “Beam axis” may be an axis that passes through an approximate center of a beam cross-section of a laser beam along the traveling direction of the laser beam.

In a beam path of a laser beam, a generation source side of the laser beam is assumed as “upstream”, and a destination side of the laser beam is assumed as “downstream”. “Beam expansion” means that a beam cross-section gradually broadens as the laser beam travels downstream along a beam path. The laser beam that is subjected to beam expansion this way is also referred to as an “expanded beam”. “Beam reduction” means that a beam cross-section gradually narrows as the laser beam travels downstream along a beam path. The laser beam that is subjected to beam reduction this way is also referred to as a “reduced beam”.

“Predetermined repetition rate” may be allowed to be an approximate predetermined repetition rate, and is not necessarily required to be a constant repetition rate. “Burst operation” may be an operation that alternately repeats a period when a pulsed laser beam is output at a predetermined repetition rate and a period when the laser beam is not output.

Excimer laser gas is a mixed gas to be a medium of an excimer laser when excited, and may include, for example, either Kr gas or Ar gas, as well as F₂ gas and Ne gas, and may further include Xe gas if desired.

“Prism” refers to an element, having a triangular column shape or a shape similar thereto, through which light including a laser beam can pass. The base surface and the top surface of the prism may have a triangular shape or a shape similar thereto. The three surfaces of the prism that intersect with the base surface and the top surface at approximately 90 degrees are referred to as side surfaces. In the case of a right-angle prism, among these side surfaces, the one side surface that does not intersect with the other two at 90 degrees is referred to as a slope surface. Here, a prism whose shape has been changed by, for example, shaving the apex of the prism can also be included as a prism in the present descriptions.

“Plane of incidence” of a reflection-type optical device is defined as a plane including both of a beam axis of a laser beam incident on the optical device and a beam axis of a laser beam reflected by the optical device. “Plane of incidence” of a transmission-type optical device is defined as a plane including both of a beam axis of a laser beam incident on the optical device and a beam axis of a laser beam having transmitted through the optical device. “S polarization” refers to a linear polarization state in a direction perpendicular to the plane of incidence defined as the above. On the other hand, “P polarization” refers to a linear polarization state in a direction perpendicular to a beam axis and parallel to the plane of incidence.

### 3. Transmissive Optical Device Using MgF₂ Crystal

A description is given about the MgF₂ crystal first before a description is given about the transmissive optical device using the MgF₂ crystal.

3.1 Structure and Physical Properties of MgF₂ Crystal

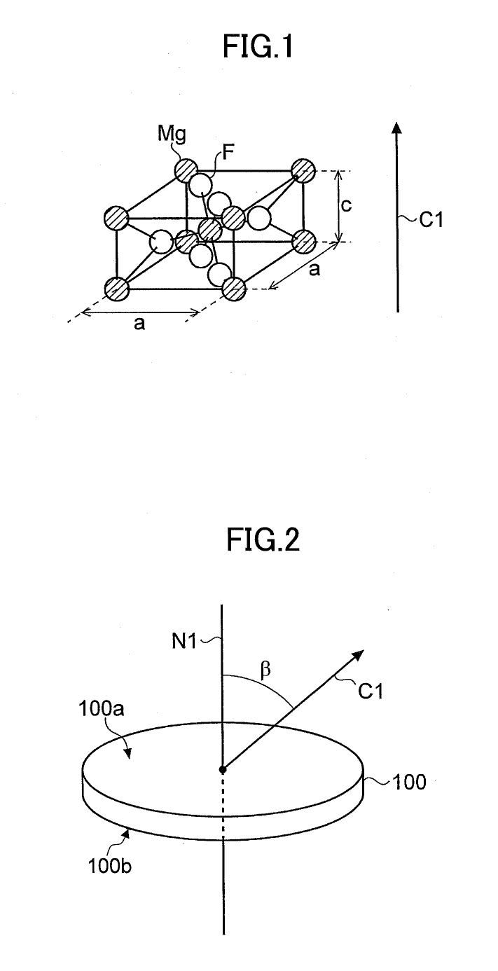

A description is given about a crystal structure and physical properties of MgF₂ crystal. FIG. 1 schematically shows a single crystal structure of the MgF₂ crystal. Table 1 lists physical properties of the MgF₂ crystal. As shown in FIG. 1 and Table 1, the MgF₂ crystal may have a tetragonal system crystal structure in which two sides with an equal lattice constant (i.e., lattice constant a=4.60 angstrom) form a square, and sides with a different lattice constant (i.e., lattice constant c=3.06 angstrom) perpendicularly intersect with the sides that form the square. In the present description, an extending direction of the side with lattice constant c is assumed as a c-axis. When the c-axis of the transmissive optical device using the MgF₂ crystal is arranged to be inclined relative to the incident axis of light, such a transmissive optical crystal can act as an optical device having birefringence depending on a polarization direction. In other words, the transmissive optical device can have a crystal part configured of the MgF₂ crystal.

TABLE 1

| | |
|---|---|
| DENSITY | 3.18 |
| REFRACTIVE INDEX | no = 1.43 |
| (λ = 193 nm) | ne = 1.45 |
| CRYSTAL STRUCTURE | TETRAGONAL SYSTEM |
| LATTICE CONSTANT[Å] | a = 4.60 |
| | c = 3.06 |
| BAND GAP[eV] | 11.8 |

As shown in Table 1, the MgF₂ crystal has a band gap of 11.8 eV (electron volt), which is, for example, higher than a band gap of a CaF₂ crystal (i.e., 10.0 eV).

By using the MgF₂ crystal that has the crystal structure and the physical properties as mentioned above, a transmissive optical device having relatively high resistance to a laser beam with a high power and a high repetition rate can be implemented.

3.2 Example of Transmissive Optical Device Using MgF₂ Crystal (Optical Window)

Next, a description is given about a transmissive optical device using the MgF₂ crystal, with an example. In the following, a description is given by citing an optical window installed in a laser chamber and the like (which is just called a window hereinafter) as an example.

FIG. 2 schematically shows an example of a window 100 using the MgF₂ crystal. As shown in FIG. 2, the window 100 may include a first principal surface 100a and a second principal surface 100b where the laser beam enters and exits. In other words, the first principal surface 100a and the second principal surface 100b can receive and/or emits the laser beam. The first principal surface 100a and the second principal surface 100b may be parallel to each other. However, the first principal surface 100a and the second principal surface 100b are not limited to the above-mentioned configuration, and may be inclined to each other, as in a wedge substrate and a prism, for example.

When the first principal surface 100a and the second principal surface 100b are parallel to each other, their normal lines may be a common normal line N1. A c-axis C1 of the MgF₂ crystal that constitutes the window 100 may be inclined relative to the normal line N1. In the following example, an inclination angle between the normal line N1 and the c-axis C1 is assumed as an angle β.

3.3 Evaluation of Polarization Property of MgF₂ Window

Next, a description is given about an evaluation of the polarization property of the window 100 shown in FIG. 2.

3.3.1 Evaluation Device

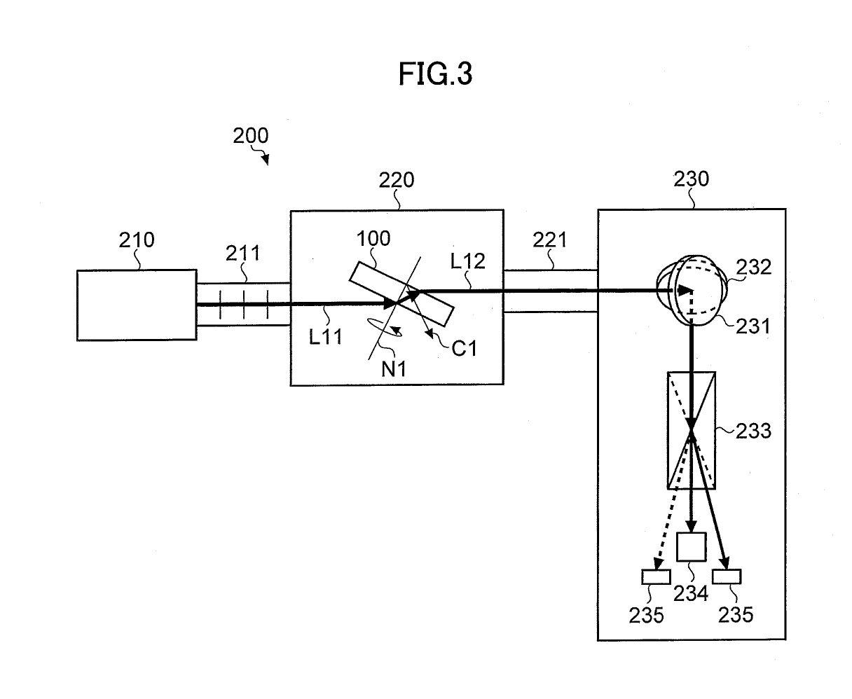

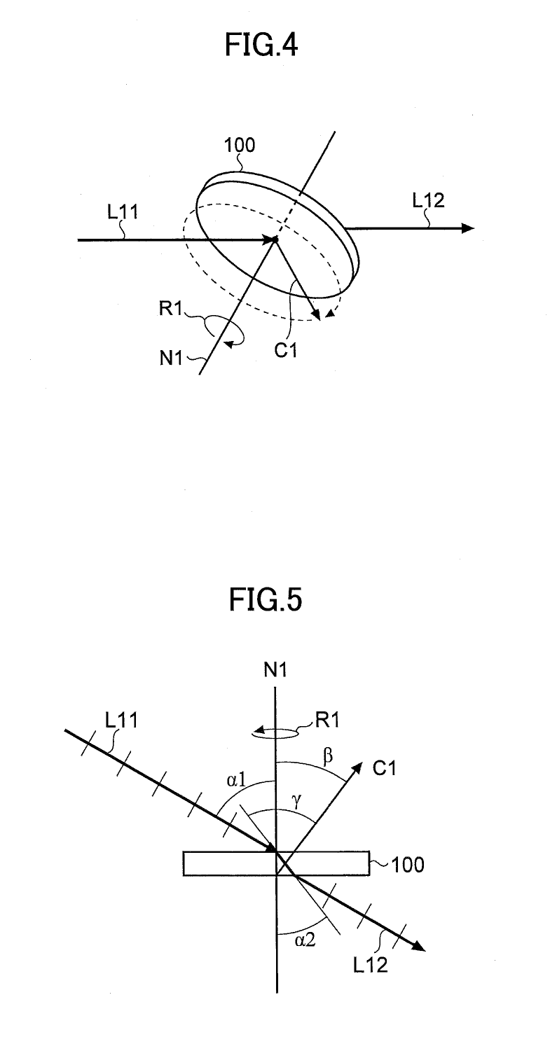

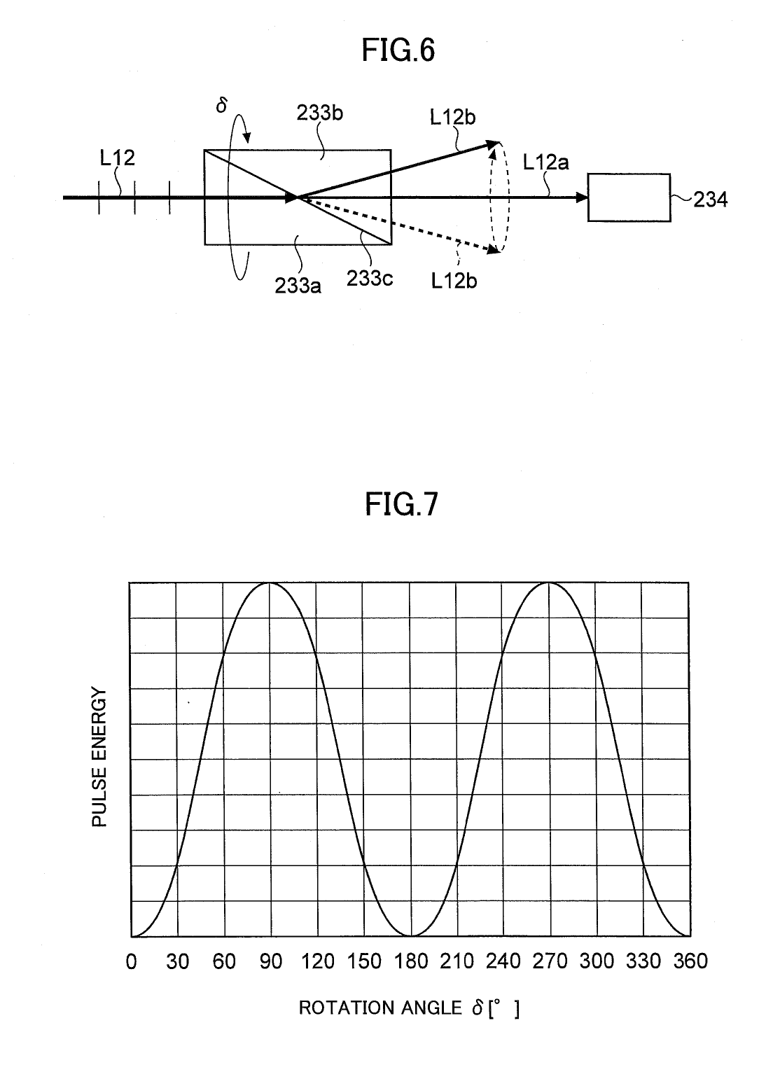

FIG. 3 shows an example of an evaluation device 200 that evaluates the polarization property of the window 100. FIG. 4 shows an arrangement example of the window 100 in the evaluation device 200 shown in FIG. 3. FIG. 5 roughly shows a configuration of the window 100 shown in FIG. 4 when cut by a plane of incidence of a laser beam L11. FIG. 6 shows an arrangement example of a rochon prism 233 and an energy sensor 234 in the evaluation device 200 shown in FIG. 3.

As shown in FIG. 3, the evaluation device 200 may include an ArF excimer laser apparatus 210, an optical waveguide 211, a measurement chamber 220, an optical waveguide 221, and a polarization degree measurement system 230.

The ArF excimer laser apparatus 210 may output the pulsed laser beam L11, for example, with a pulse energy of 10 mJ (millijoule). The laser beam L11 may be linearly-polarized light parallel to a plane of paper of FIG. 3. The laser beam L11 may enter the measurement chamber 220 through the optical waveguide 211. The inside of the measurement chamber 220 may be filled with nitrogen (N₂) gas. The optical waveguide 211 may connect the ArF excimer laser apparatus 210 and the measurement chamber 220, while shielding a beam path of the laser beam L11 from the atmosphere.

The window 100 may be a MgF₂ crystal substrate cut by a (1 1 1) plane. Here, the (1 1 1) is a Miller index to express a crystal plane. The window 100 may be arranged in the measurement chamber 220 that is filled with the N₂ gas. As shown in FIGS. 4 and 5, the window 100 may be arranged to be inclined at an incidence angle to be inclined when actually installed in a laser chamber relative to the incident direction of the laser beam L11 (which is hereinafter also called a beam path). Here, the incidence angle may be set at, for example, Brewster's angle. An inclination angle of an beam axis of the laser beam L11 relative to the normal line N1 is assumed as an incidence angle α1. Moreover, the window 100 may be held to be rotatable in a rotational direction R1 around the normal line N1, which is assumed as the central axis.

As shown in FIG. 3, the laser beam L12 having transmitted through the window 100 may enter the polarization degree measurement system 230 through the optical waveguide 221. The optical waveguide 221 may connect the measurement chamber 220 and the polarization degree measurement system 230, while shielding a beam path of the laser beam L12 from the atmosphere.

The polarization degree measurement system 230 may include the rochon prism 233 and the energy sensor 234. The polarization degree measurement system 230 may include an optical system that folds the beam path of the laser beam L12 having transmitted through the window 100. Preferably, this optical system may be configured to ensure that there is no change in the polarization degree of the laser beam L12 between before and after the passing of the laser beam L12. In the present example, the optical system includes two folding mirrors 231 and 232. In this case, respective inclining directions may preferably have a difference of 90 degrees relative to the beam axis of the laser beam L12, for example, in a way that the laser beam L12 incident on one folding mirror 231 as P polarization light enters the other folding mirror 232 as S polarization light.

The laser beam L12 having passed through the optical system configured of the folding mirrors 231 and 232 may enter the rochon prism 233. As shown in FIG. 6, the rochon prism 233 may have a configuration in which two prisms 233a and 233b are bonded. The bonded surface between the two prisms 233a and 233b may be an optical contact surface 233c. The rochon prism 233 may be rotatable around the beam axis of the incident laser beam L12, which is assumed as the rotational axis.

A laser beam L12a of P polarization light among the laser beams L12 incident on the optical contact surface 233c can be emitted on an extended line of the beam path of the laser beam L12 on the incidence side. Therefore, the energy sensor 234 may be preferably arranged on the extended line of the beam path of the laser beam L12 on the incidence side. On the other hand, a laser beam L12b of S polarization light among the laser beams L12 incident on the optical contact surface 233c can be emitted at an angle relative to the extended line of the beam path of the laser beam L12 on the incidence side. Therefore, a ring-shaped beam dumper 235 for absorbing the laser beam Ll2b may be arranged on the extended line of the laser beam L12b.

3.3.2 Method of Measuring Polarization Degree

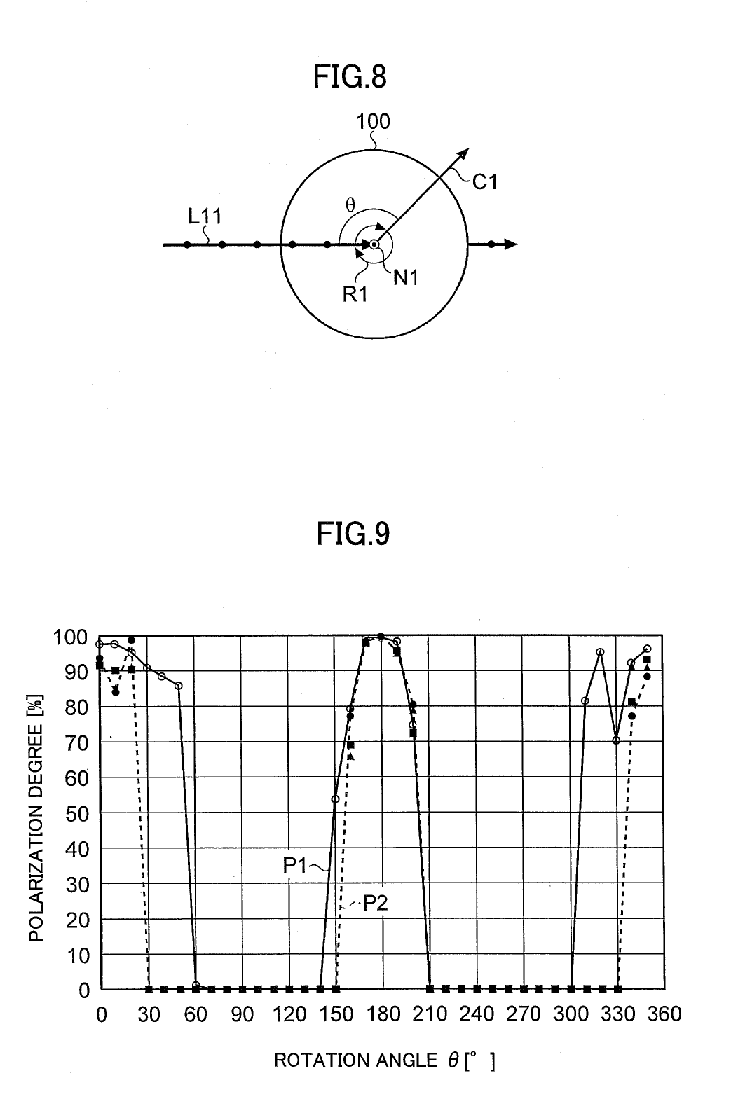

FIG. 7 shows a pulse energy value of the laser beam L12b measured by the energy sensor 234 relative to a rotation angle δ of the rochon prism 233 shown in FIG. 6. FIG. 8 roughly shows a configuration of the window 100 shown in FIG. 3 when seen from and on the normal line N1.

In the configuration shown in FIG. 6, the rochon prism 233 may be rotated around the beam axis of the laser beam L12, which is assumed as the rotation axis, while ensuring that there is no change in the polarization state of the laser beam L12 incident thereon. In this case, as shown in FIG. 7, the pulse energy detected by the energy sensor 234 changes with respect to the rotation angle δ in cycles of 180 degrees. Here, when the polarization state of the laser beam L12 is a complete linear polarization, the minimum value Imin of the pulse energy detected by the energy sensor 234 may be zero. In FIG. 7, a case is illustrated in which the laser beam L12 enters the optical contact surface 233c as complete S polarization light when the angle of the c-axis C1 relative to the beam axis of the laser beam L11 is a standard angle in the window 100 in FIG. 8. Furthermore, in the present description, an angle formed by the beam axis of the laser beam L11 projected on the first principal surface 100a when the first principal surface 100a of the window 100 is seen from and on the normal line N1 and the c-axis C1 projected on the first principal surface 100a is made an angle θ. A definition of the angle θ may be similarly applied to the relationship between the beam axis of the laser beam L11 and the c-axis C1 with respect to the second principal surface 100b of the window 100. The case of the angle θ being 0 degrees is assumed to be the standard angle of the c-axis (see FIG. 8).

Then, as shown in FIG. 8, the window 100 shown in FIGS. 4 and 5 is rotated a certain angle from the standard angle in a rotational direction R1. At this time, a polarization degree P of the laser beam L12 is measured in the process of rotating the rochon prism 233 shown in FIG. 6 from 0 degrees to 180 degrees (or 360 degrees), while the window 100 is maintained at the rotation angle. The polarization P can be calculated by using the following formula (1) from the maximum value Imax and the minimum value Imin of the pulse energy value detected in the process. In the present description, the rotational direction R1 may be a rotational direction in a plane parallel to the first principal surface 100a and the second principal surface 100b.

$$P = \frac{{I}_{max} - {I}_{min}}{{I}_{max} + {I}_{min}} \qquad ( 1 )$$

3.3.3 Polarization Property Evaluation Results

FIG. 9 shows a polarization degree property obtained in the process of rotating the window 100 three hundred sixty degrees in the rotational direction R1 in the evaluation device 200 shown in FIG. 3. FIG. 9 shows a polarization degree obtained at each rotation angle θ when the rotation angle θ of the window 100 is rotated at 10-degree increments. In measuring the polarization degree shown in FIG. 9, the incidence angle α1 shown in FIG. 5 was set to 60.5 degrees, which is close to the Brewster's angle, and the angle β was set to 37.38 degrees. In this case, an angle α2 formed by the beam axis of the laser beam L11 that travels through the window 100 and the normal line N1 becomes 37.38 degrees from Snell's law shown in the following formula (2) (see FIG. 5). Accordingly, an angle γ (=α2+β) formed by the beam axis of the laser beam L11 traveling through the window 100 and the c-axis C1 becomes 74.76 degrees (see FIG. 5). Here, a refractive index of a space in which the window 100 is provided is set to 1.

sin α1=n×sin α2 (2)

n: a refractive index of MgF₂ crystal relative to a wavelength of the laser beam L11

In FIG. 9, white circles and a solid line P1 show a polarization property when an irradiation power of the laser beam L11 output from the ArF excimer laser apparatus 210 is set to 2 W (watt) (pulse energy 10 mJ, repetition rate 200 Hz). Also, black circles and a dashed line P2 show a polarization property when the irradiation power of the laser beam L11 is set to 10 W (pulse energy 10 mJ, repetition rate 1000 Hz). Black squares show a polarization property when the irradiation power of the laser beam L11 is set to 30 W (pulse energy 10 mJ, repetition rate 3000 Hz). Black triangles show a polarization property when the irradiation power of the laser beam L11 is set to 60 W (pulse energy 10 mJ, repetition rate 6000 Hz).

As shown in FIG. 9, when the rotation angle θ is around 0 degrees (and 360 degrees equal to 0 degrees), the polarization degree P is equal to or more than 90% if the irradiation power of the laser beam L11 is 2 W (watt) (which is shown by white circles and solid line P1), but the polarization degree P is decreased as the irradiation power of the laser beam L11 is increased.

In addition, when the rotation angle θ is in a range from 170 degrees to 190 degrees, the polarization degree P is maintained to be equal to or more than 95% for an irradiation power of the laser beam L11 from 2 W to 60 W. In particular, when the rotation angle θ is around 180 degrees, the polarization degree P is equal to or more than 98%. This is maintained even when the irradiation power of the laser beam L11 is increased.

As discussed above, it is noted that the rotation angle θ is preferably about 180 degrees. In particular, by setting the rotation angle θ of 170 degrees to 190 degrees, the polarization degree P of substantially equal to or more than 95% can be obtained. Moreover, by setting the rotation angle θ of 175 degrees to 185 degrees, the polarization degree P of substantially equal to or more than 97.5% can be obtained. Furthermore, by setting the rotation angle θ of 179 degrees to 181 degrees, the polarization degree P of substantially equal to or more than 98% can be obtained.

When the angle β shown in FIG. 5 was set to 37.38 degrees; the rotation angle θ was set to 180 degrees; and the irradiation power of the laser beam L11 was set to 60 W (pulse energy 15 mJ, repetition rate 4000 Hz), the polarization degree P of 98.6% was obtained. This polarization degree is a value applicable to a lithography apparatus used for general semiconductor lithography. From the above discussed results, it can be said that a new finding has been acquired that a favorable polarization degree can be obtained when MgF₂ crystal with a relative high resistance to a laser beam with a high power and a high repetition frequency is used by forming a predetermined configuration and arrangement.

### 4. First Example of MgF₂ Window

### First Embodiment

Based on the above description, a description is given about a transmissive optical device of a first embodiment of the present disclosure. In the following description, a window 100A is taken as an example. In the present disclosure, a semi-transmissive optical device such as a partially reflecting mirror or the like is included in the transmissive optical device.

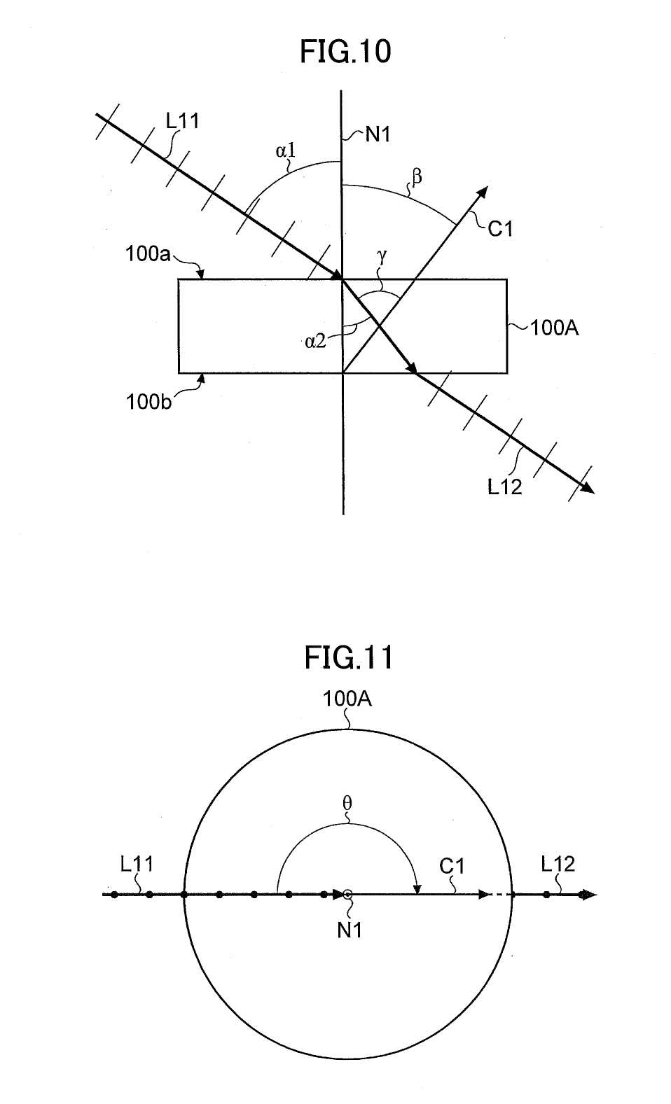

FIGS. 10 and 11 roughly show a configuration of the window 100A of the first embodiment. More specifically, FIG. 10 shows a cross-sectional structure of the window 100A when cut by a plane including the plane of incidence of the laser beam L11. FIG. 11 shows a configuration of the window 100A when seen from and on the normal line N1.

As shown in FIGS. 10 and 11, an arrangement of the window 100A may be similar to the arrangement of the above-mentioned window 100. Accordingly, a c-axis C1 of MgF₂ crystal constituting the window 100A is inclined relative to the normal line N1 of a first principal surface 100a and a second principal surface 100b of the MgF₂ crystal. An angle of the inclination is an angle β.

A rotation angle θ in FIG. 11 may be preferably 180 degrees. However, the rotation angle θ is not limited to this, and as described above by using FIG. 9, by allowing the rotation angle θ to be included in a range of the following formula (3), a polarization degree equal to or more than 95% can be obtained.

170 degrees≦θ≦190 degrees (3)

More preferably, by allowing the rotation angle θ to be included in a range of the following formula (4), a polarization degree equal to or more than 97% can be obtained.

175 degrees≦θ≦185 degrees (4)

Much more preferably, by allowing the rotation angle θ to be included in a range of the following formula (5), a polarization degree equal to or more than 98% can be obtained.

179 degrees≦θ≦181 degrees (5)

In addition, as discussed above, an angle of an inclination of the beam axis of the incident laser beam L11 relative to the normal line N1 is an incidence angle α1.

Moreover, with respect to the refractive index of the MgF₂ crystal, as shown in Table 1 above, the refractive index no equals 1.43, and the refractive index ne equals 1.45. Hence, the Brewster's angle θb is as shown in the following formulas (6) and (7).

θb=tan⁻¹(no)=55.0 degrees(in the case of no=1.43) (6)

θb=tan⁻¹(ne)=55.4 degrees(in the case of ne=1.45) (7)

The angle α1 may be preferably close to the Brewster's angle θb. Because of this, the incidence angle α1 of the laser beam L11 incident on the window 100A is preferably included in a range of the following formula (8).

45 degrees≦α1≦70 degrees (8)

More preferably, the incidence angle α1 is included in a range of the following formula (9).

50 degrees≦α1≦65 degrees (9)

Much more preferably, the incidence angle α1 is included in a range of the following formula (10).

54 degrees≦α1≦56.4 degrees (10)

Furthermore, an angle γ formed by the beam axis of the laser beam L11 in the window 100A and the c-axis C1 is preferably close to 90 degrees. Due to this, the angle γ is preferably included in a range of the following formula (11).

60 degrees≦γ≦110 degrees (11)

More preferably, the angle γ is included in a range of the following formula (12).

70 degrees≦γ≦100 degrees (12)

Much more preferably, the angle γ is included in a range of the following formula (13).

85 degrees≦γ≦95 degrees (13)

By arranging the above-mentioned window 100A configured of the MgF₂ crystal so as to meet the above conditions for the beam axis of the laser beam L11, the window 100A having relatively high resistance to the laser beam with a high power and a high repetition rate can be implemented. In addition, it may be possible to enhance a polarization degree of the transmitted laser beam. However, among the above conditions, the conditions except for the rotation angle θ are used to obtain a better optical property, but are not essential conditions.

### 5. Second Example of MgF₂ Window

### Second Embodiment

The transmissive optical device using the MgF₂ crystal may also be configured as illustrated in a second embodiment below. In the following description, a window 100B is taken as an example.

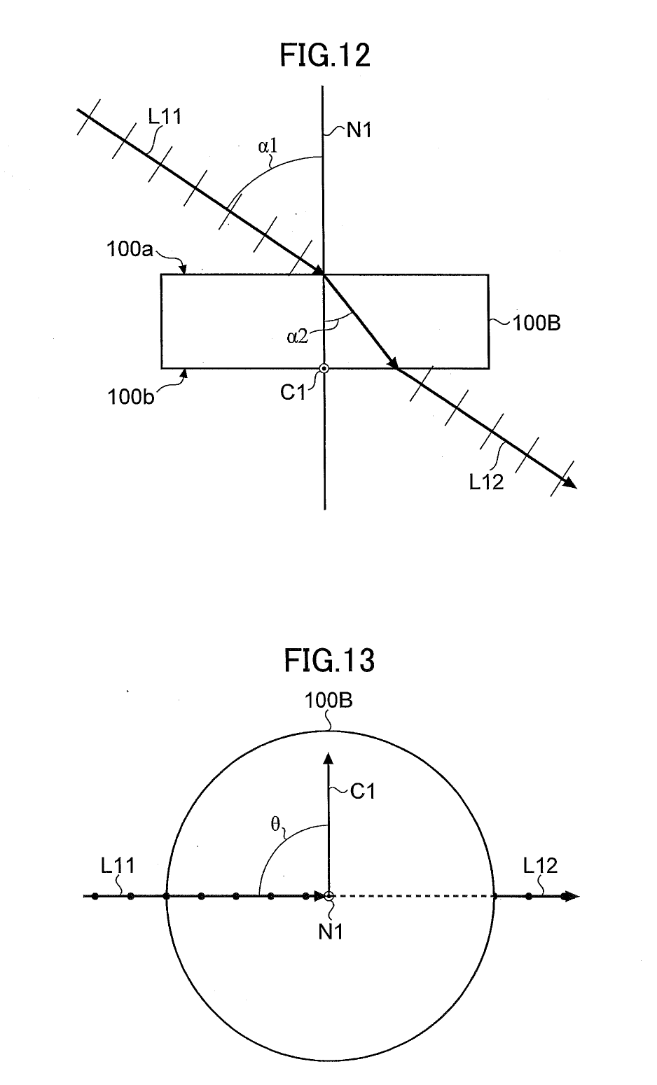

FIGS. 12 and 13 roughly show a configuration of the window 100B of the second embodiment. More specifically, FIG. 12 shows a cross-sectional structure of the window 100B when cut by a plane including the plane of incidence of the laser beam L11. FIG. 13 shows a configuration of the window 100B when seen from and on the normal line N1.

As shown in FIGS. 12 and 13, in the window 100B, a direction of a c-axis C1 may be parallel to a first principal surface 100a and a second principal surface 100b. As long as the direction of the c-axis C1 is parallel to the first principal surface 100a and/or the second principal surface 100b, an angle γ formed by the beam axis of the laser beam L11 and the c-axis C1 may become 90 degrees, which can be derived from the above finding.

A direction of the c-axis referenced to the plane of incidence of the laser beam L11, that is to say, a rotation angle θ in FIG. 11, is preferably 90 degrees. However, the angle θ is not limited to this, and the rotation angle θ is preferably included in a range of the following formula (14).

80 degrees≦θ≦100 degrees (14)

More preferably, the rotation angle θ is included in a range of the following formula (15).

85 degrees≦θ≦95 degrees (15)

Much more preferably, the rotation angle θ is included in a range of the following formula (16).

89 degrees≦θ≦91 degrees (16)

Furthermore, the incidence angle α1 of the laser beam L11 incident on the window 100B is preferably included in a range of the following formula (17) with respect to the relation to the Brewster's angle θb.

45 degrees≦α1≦70 degrees (17)

More preferably, the incidence angle α1 is included in a range of the following formula (18).

50 degrees≦α1≦65 degrees (18)

Much more preferably, the incidence angle α1 is included in a range of the following formula (19).

54 degrees≦α1≦56.4 degrees (19)

By arranging the above-mentioned window 100B configured of the MgF₂ crystal so as to meet the above conditions for the beam axis of the laser beam L11, the window 100B having relatively high resistance to the laser beam with a high power and a high repetition rate can be implemented, as in the first embodiment. In addition, it is possible to enhance a polarization degree of the transmitted laser beam. However, among the above conditions, the conditions except for the rotation angle θ are used to obtain a better optical property, but are not essential conditions.

### 6. First Example of Amplifier Stage Laser Device Including Transmissive Optical Device Configured of MgF₂ Crystal

### Third Embodiment

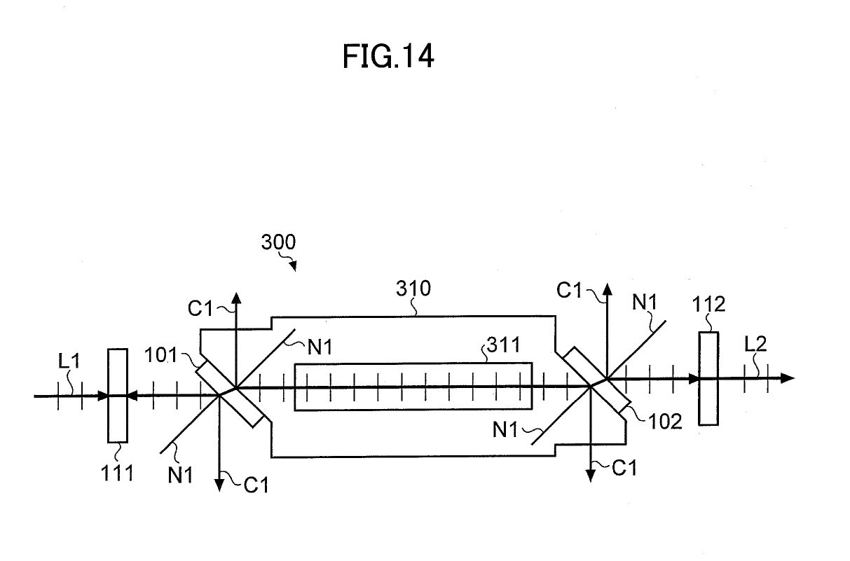

Subsequently, a detailed description is given about an example of an amplifier stage laser device including the above-discussed transmissive optical device with reference to the drawings. FIG. 14 roughly shows a configuration of an amplifier stage laser device 300 including a stable resonator of the third embodiment. As shown in FIG. 14, the amplifier stage laser device 300 may include two partially reflecting mirrors 111 and 112, and a laser chamber 310. The two partially reflecting mirrors 111 and 112 may constitute an optical resonator. The partially reflecting mirror 112 on the downstream side may function as an output coupler.

In the laser chamber 310, windows 101 and 102 where a laser beam L1 propagating through the optical resonator enters and exits may be provided. An installation angle of the windows 101 and 102 relative to the beam axis of the laser beam L1 may be the above-mentioned incidence angle α1. The laser beam L11 may enter the respective windows 101 and 102, for example, as P polarization light.

The inside of the laser chamber 310 may be filled with excimer laser gas. Inside the laser chamber 310, a pair of discharge electrodes 311 connected to a power source (not shown in drawings) may be arranged. A direction of discharge by the discharge electrodes 311 may be, for example, a direction perpendicular to a plane including both of the beam axis and a polarization component of the laser beam L1.

In the above-mentioned configuration, each of the windows 101 and 102 and the partially reflecting mirrors 111 and 112 may be a transmissive optical device using the MgF₂ crystal according to the above-mentioned first or second embodiment. For example, each of the windows 101 and 102 may be the window 100A of the first embodiment or the window 100B of the second embodiment. Moreover, each of the partially reflecting mirrors 111 and 112 may have a configuration in which the window 100A of the first embodiment or the window 100B of the second embodiment is used as a substrate. A high transmission film that provides the high transmission of the laser beam L1 may be formed on the first principal surface 100a of this substrate, and a partially reflecting film that partially reflects the laser beam L1 may be formed on the second principal surface 100b.

Here, the partially reflecting mirrors 111 and 112 constituting the stable resonator are, for example, arranged so that the normal line N1 of the entrance/exit surfaces of the laser beam L1 (corresponding to the first principal surface 100a and the second principal surface 100b) is parallel to the beam axis of the laser beam L1. In this case, the c-axis of each of the partially reflecting mirrors 111 and 112 may be arranged so as to be parallel to a plane including the c-axis C1 of the window 101 or the c-axis C1 of the window 102, and the beam axis of the laser beam L1.

As discussed above, the transmissive optical device using the MgF₂ crystal of the first and second embodiments may be applied not only to the windows 101 and 102, but also to the transmissive optical device such as the partially reflecting mirrors 111 and 112.

### 7. Second Example of Amplifier Stage Laser Device Including Transmissive Optical Device Configured of MgF₂ Crystal

### Fourth Embodiment

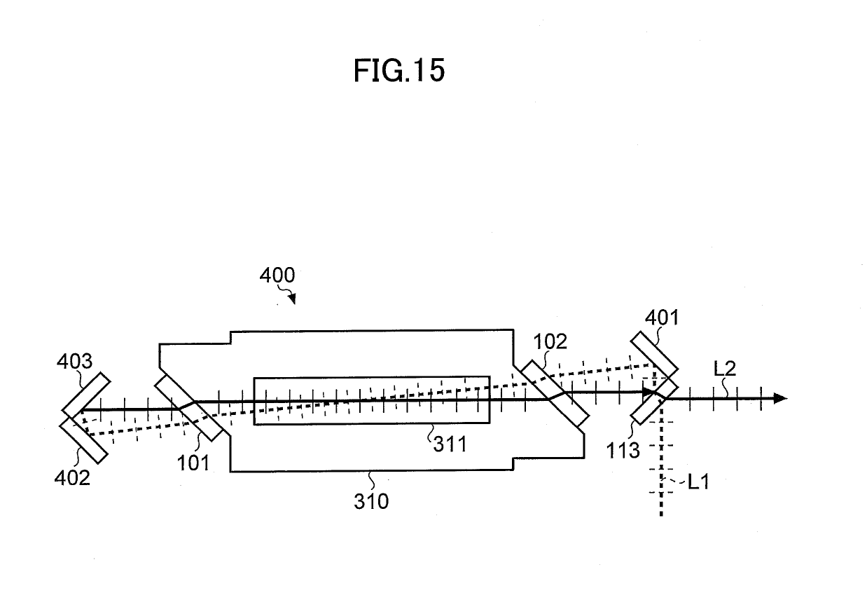

The above-mentioned transmissive optical device may be utilized for an amplifier stage laser device including a ring resonator. FIG. 15 roughly shows a configuration of an amplifier stage laser device 400 including a ring resonator of the fourth embodiment. As shown in FIG. 15, the amplifier stage laser device 400 may include a partially reflecting mirror 113, three high reflectivity mirrors 401 to 403, and a laser chamber 310. The laser chamber 310 may be similar to the laser chamber 310 shown in FIG. 14.

The partially reflecting mirror 113 may function as an entrance optical device for a laser beam L1 and an exit optical device for an amplified laser beam L2. The ring resonator may be configured with the partially reflecting mirror 113 and the high reflectivity mirrors 401 to 403 as resonator mirrors. The laser chamber 310 may be arranged on the optical path of the ring resonator. In such a configuration, the components are preferably configured and arranged so that the laser beam L1 going through the ring resonator meets the conditions illustrated in the above-mentioned first or second embodiment of different two beam paths for each or any of the windows 101 and 102 of the laser chamber 310.

In the above configurations, each of the windows 101 and 102 of the laser chamber 310 and the partially reflecting mirror 113 may be a transmissive optical device using the MgF₂ crystal according to the above-mentioned first or second embodiment. Moreover, the partially reflecting mirror 113 is preferably arranged so that the rotation angle θ relative to the beam axis of the laser beam L1 meets the conditions illustrated in the first or second embodiment. In this case, the beam axis of the amplified laser beam L2 transmitting through the partially reflecting mirror 113 is preferably included in a plane including both of the beam axis of the laser beam L1 incident on the partially reflecting mirror 113 and the c-axis C1 of the partially reflecting mirror 113. Furthermore, this plane may also include the c-axis of the windows 101 and 102. In addition, the polarization components of the laser beams L1 and L2 may be parallel to this plane.

As discussed above, the transmissive optical device using the MgF₂ crystal of the first and second embodiments may be applied not only to the windows 101 and 102, but also to the transmissive optical device such as the partially reflecting mirror 113.

### 8. First Example of Laser Apparatus Including Transmissive Optical Device Configured of MgF₂ Crystal

### Fifth Embodiment

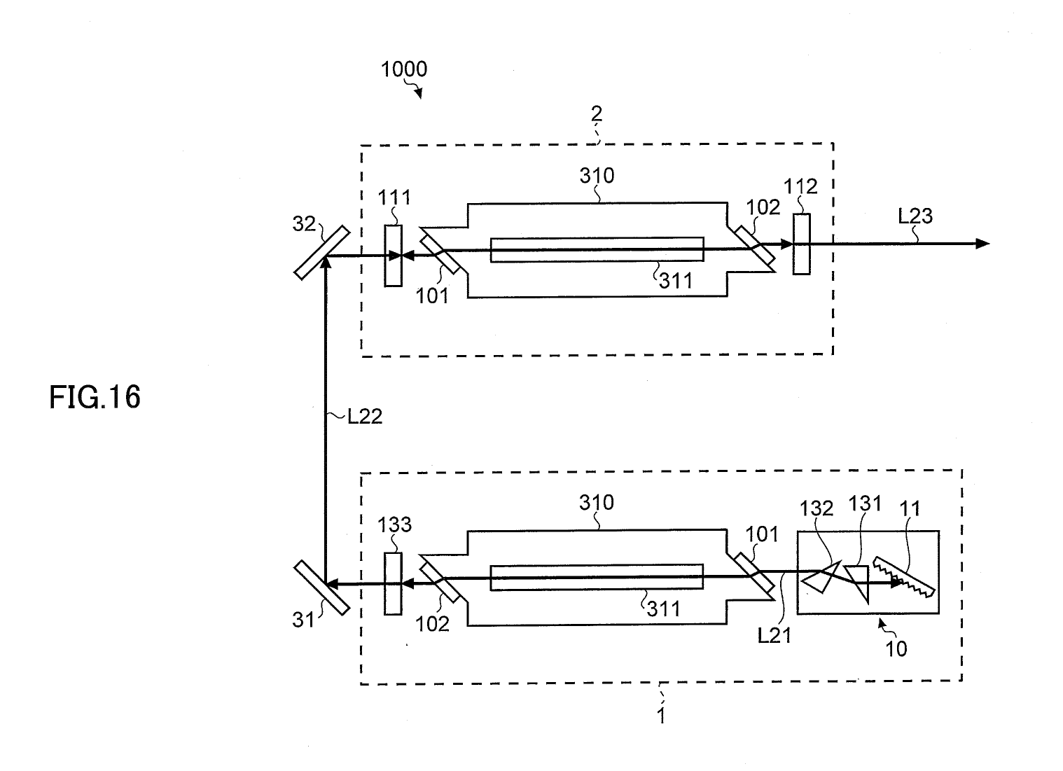

A detailed description is given about an example of a laser apparatus including the transmissive optical device described above with reference to the drawings. FIG. 16 roughly shows a configuration of a two-stage type laser apparatus 1000 of a fifth embodiment.

As shown in FIG. 16, the laser apparatus 1000 may include an oscillation stage laser device 1 and an amplifier stage laser device 2. Among these, the amplifier stage laser device 2 may be, for example, similar to the amplifier stage laser device 300 shown in FIG. 14. However, the amplifier stage laser device 2 is not limited to the amplifier stage laser device 300 in FIG. 4, and the amplifier stage laser device 400 shown in FIG. 15 may be used.

The oscillation stage laser device 1 may include, for example, a line narrowing module 10, a laser chamber 310, and an output coupler 133. The laser chamber 310 may be similar to the laser chamber 310 shown in FIG. 14. Also, an arrangement of the output coupler 133 may be similar to the arrangement of the partially reflecting mirror 112 shown in FIG. 14.

The line narrowing module 10 may include a grating 11 and plural prisms 131 and 132. The grating 11 may constitute an optical resonator with the output coupler 133. Moreover, the grating 11 may function as a wavelength selection part that selects a wavelength of a laser beam L21 that exists in the optical resonator. The prisms 131 and 132 may be provided for the purpose of adjusting a beam width and a beam path of the laser beam L21 incident on the grating 11. The number of the prisms is not limited to two.

A laser beam L22 emitted from the oscillation stage laser device 1 may enter the amplifier stage laser device 2 by way of an optical system including the high reflectivity mirrors 31 and 32. The amplifier stage laser device 2 may amplify the incident laser beam L22 and emit the amplified laser beam as a laser beam L23.

Each of the arrangements of the windows 101 and 102 of the respective laser chambers 310 of the oscillation stage laser device 1 and the amplifier stage laser device 2, and the partially reflecting mirrors 111, 112 and 133 may be similar to the arrangement of the transmissive optical device of the above-mentioned first or second embodiment. Each of the arrangements of the prisms 131 and 132 may be similar to the arrangement of the window 100A of the first embodiment or the arrangement of the window 100B of the second embodiment. However, even when a window of either embodiment is used for the windows 101 and 102, two respective entrance/exit surfaces of the prisms 131 and 132 corresponding to the first principal surface 100a and the second principal surface 100b are not parallel to each other. In such a case, the conditions in the above embodiments may be applied to the prisms 131 and 132, for example, by using one of the entrance/exit surfaces as a reference. For example, the prism 132 may be arranged so that of the entrance/exit surface on the laser chamber 310 side and the entrance/exit surface on the grating 11 side, a normal line of the entrance/exit surface on the laser chamber 310 side is inclined at an incidence angle α1 with respect to the beam axis of the laser beam L21. In this case, the rotation angle θ of the c-axis C1 using the entrance/exit surface of the laser beam L21 as a reference, an angle β formed by the normal line N1 and the c-axis C1, and an angle γ formed by the beam axis of the laser beam L21 in the prism 132 and the c-axis C1 may be set with the entrance/exit surface on the laser chamber 310 side used as a reference. However, these angles are not limited to this example, and may be set with the entrance/exit surface on the grating 11 side used as a reference. This may be applied to a wedge substrate if the wedge substrate is used in place of the prism or the window.

As discussed above, even when the two entrance/exit surfaces of the transmissive optical device such as the partially reflecting mirrors 111, 112 and 113, and the prisms 131 and 132 are not parallel to each other, the configuration and arrangement of the transmissive optical device using the MgF₂ crystal of the first and second embodiments may be applied to the transmissive optical devices.

### 9. Second Example of Laser Apparatus Including Transmissive Optical Device Configured of MgF₂ crystal

### Sixth Embodiment

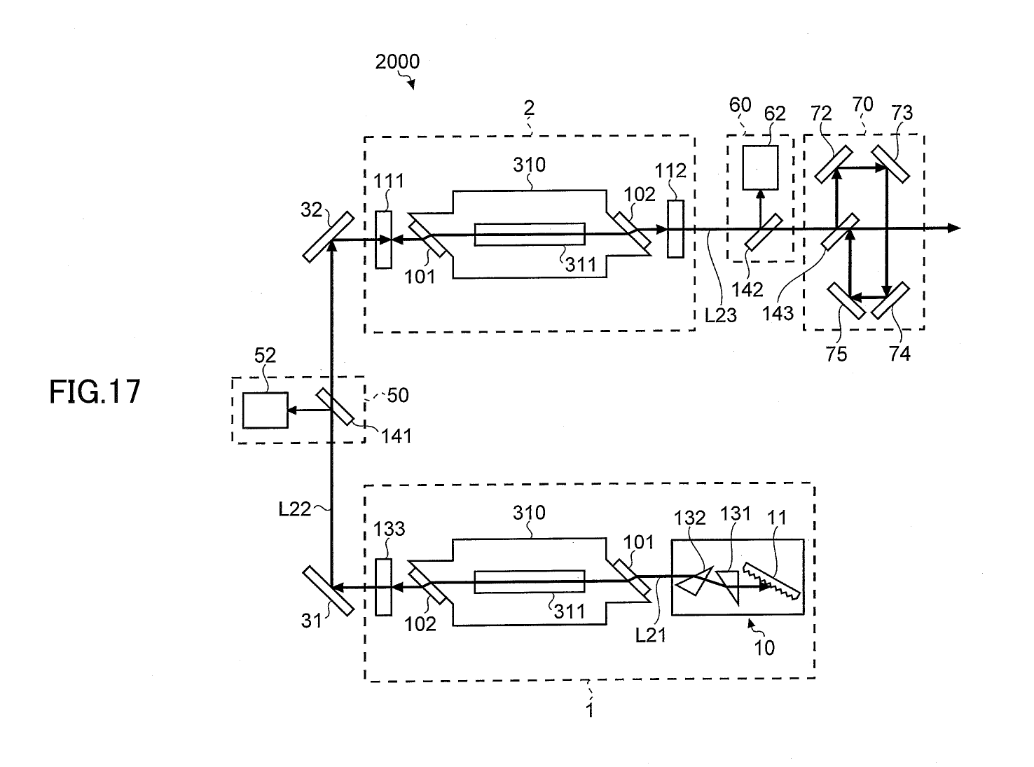

The transmissive optical device described above is not limited to the oscillation stage laser device, the amplifier stage laser device, the optical resonator and the like, and may be applied to a detector and other optical systems. FIG. 17 roughly shows a configuration of a laser apparatus 2000 including detectors 50 and 60 and a pulse stretcher 70 of a sixth embodiment.

As shown in FIG. 17, the laser apparatus 2000, similarly to the laser apparatus 1000 shown in FIG. 16, may include an oscillation stage laser device 1, an amplifier stage laser device 2, and an optical system including two high reflectivity mirrors 31 and 32. Moreover, the laser apparatus 2000 may further include the two detectors 50 and 60, and the pulse stretcher 70. The oscillation laser 1, the amplifier stage laser device 2, and the optical system including the two high reflectivity mirrors 31 and 32 may be similar to those shown in FIG. 16. A polarization component of the laser beam L22 output from the oscillation stage laser device 1 may be, for example, in a direction parallel to the drawing sheet of FIG. 17.

The detector 50 may be arranged, for example, on a beam path between the oscillation stage laser device 1 and the amplifier stage laser device 2. The detector 50 may include a beam splitter 141 that splits a beam path of the laser beam L22, and a photosensor 52 that detects various parameters of the split laser beam L22. The beam splitter 141 is preferably arranged so that an arrangement of a c-axis relative to the beam axis of the laser beam L22 meets the conditions illustrated in the first or second embodiment.

Moreover, an arrangement of a beam splitter 142 on the laser output side of the amplifier stage laser device 2 may also be, for example, similar to the arrangement of the beam splitter 141 in the detector 50. A photosensor 62 of the detector 60 may detect the various parameters of the split laser beam L23.

Furthermore, in the pulse stretcher 70 arranged on an beam path of the laser beam L23 having passed through the detector 60, an arrangement of a beam splitter 143 located at a laser input stage may also be, for example, similar to the arrangement of the beam splitter 141 in the detector 50. The pulse stretcher 70 may include, in addition to the beam splitter 143, plural high reflectivity mirrors 72 to 75 that form a ring-shaped optical path including the beam splitter 143.

Moreover, the laser apparatus 2000 is not limited to the detectors 50 and 60 or the pulse stretcher 70, and may include, for example, other optical systems such as a coherence reduction mechanism that reduces coherence of a laser beam, an optical shutter that implements burst output of the laser beam L23 or prevents optical feedback from a target substance irradiated with a laser beam from entering the laser apparatus, and the like. On this occasion, the arrangement of the transmissive optical device using the MgF₂ crystal of the above first or second embodiment may be applied to the arrangements of the transmissive optical devices included in these optical systems.

The aforementioned descriptions are intended to be taken only as examples, and are not to be seen as limiting in any way. Accordingly, it will be clear to those skilled in the art that variations of the embodiments of the present disclosure can be made without departing from the scope of the appended claims.

The terms used in the present specification and in the entirety of the scope of the appended claims are to be interpreted as not being limiting. For example, wording such as “includes” or “is included” should be interpreted as not being limited to the item that is described to include or be included. Furthermore, “has” should be interpreted as not being limited to the item that is described to have. Furthermore, the indefinite article “a” or “an” as used in the present specification and the scope of the appended claims should be interpreted as meaning “at least one” or “one or more”.

What is claimed is:

1. A transmissive optical device comprising:
a crystal part including a c-axis in a crystal structure, the crystal part being configured to include a surface to receive a laser beam,
wherein the c-axis is arranged to be inclined relative to an incident direction of the laser beam in a plane of incidence of the laser beam.

2. The transmissive optical device as claimed in claim 1,
wherein the crystal part is configured of a MgF₂ crystal.

3. The transmissive optical device as claimed in claim 1,
wherein a rotation angle of the c-axis relative to the plane of incidence in a plane parallel to the surface is in a range from 170 degrees to 190 degrees.

4. The transmissive optical device as claimed in claim 1,
wherein a rotation angle of the c-axis relative to the plane of incidence in a plane parallel to the surface is in a range from 175 degrees to 185 degrees.

5. The transmissive optical device as claimed in claim 1,
wherein a rotation angle of the c-axis relative to the plane of incidence in a plane parallel to the surface is in a range from 179 degrees to 181 degrees.

6. The transmissive optical device as claimed in claim 1,
wherein the crystal part is arranged so that the incident direction of the laser beam is inclined at Brewster's angle to a normal line of the surface.

7. The transmissive optical device as claimed in claim 1,
wherein the crystal part is configured to be one of a window, a beam splitter and a prism.

8. A laser chamber comprising:
a pair of electrodes to generate a discharge; and
a window configured of the transmissive optical device as claimed in claim 1, the window being arranged on an beam path of a laser beam and outside the pair of electrodes to receive the laser beam.

9. An amplifier stage laser device comprising:
a pair of electrodes to generate a discharge;
a window to receive a laser beam arranged on an beam path of the laser beam and outside the pair of the electrodes; and
an output coupler arranged on the beam path and outside the window,
wherein at least one of the window and the output coupler is configured of the transmissive optical device as claimed in claim 1.

10. An oscillation stage laser device comprising:
a pair of electrodes to generate a discharge;
a window to receive a laser beam arranged on an beam path of the laser beam and outside the pair of the electrodes;
an output coupler arranged on the beam path and outside the window; and
a prism arranged on the beam path and outside the window opposite to the output coupler,
wherein at least one of the window, the output coupler and the prism is configured of the transmissive optical device as claimed in claim 1.

11. A laser apparatus comprising:
a pair of electrodes to generate a discharge;
a window to receive a laser beam arranged on an beam path of the laser beam and outside the pair of the electrodes;
an output coupler arranged on the beam path and outside the window; and
a prism arranged on the beam path and outside the window opposite to the output coupler;
a beam splitter arranged on the beam path,
wherein at least one of the window, the output coupler, the prism and the beam splitter is configured of the transmissive optical device as claimed in claim 1.

12. A transmissive optical device comprising:
a crystal part including a c-axis in a crystal structure, the crystal part being configured to include a surface to receive a laser beam,
wherein the c-axis is arranged to be substantially parallel to the surface and substantially perpendicular to a plane of incidence of the laser beam.

13. The transmissive optical device as claimed in claim 12,
wherein the crystal part is configured of a MgF₂ crystal.

14. The transmissive optical device as claimed in claim 12,
wherein a rotation angle of the c-axis relative to the plane of incidence in a plane parallel to the surface is in a range from 80 degrees to 100 degrees.

15. The transmissive optical device as claimed in claim 12,
wherein a rotation angle of the c-axis relative to the plane of incidence in a plane parallel to the surface is in a range from 85 degrees to 95 degrees.

16. The transmissive optical device as claimed in claim 12,
wherein a rotation angle of the c-axis relative to the plane of incidence in a plane parallel to the surface is in a range from 89 degrees to 91 degrees.

17. The transmissive optical device as claimed in claim 12,
wherein the crystal part is arranged so that the incident direction of the laser beam is inclined at Brewster's angle to a normal line of the surface.

18. The transmissive optical device as claimed in claim 12,
wherein the crystal part is configured to be one of a window, a beam splitter and a prism.

19. A laser chamber comprising:
a pair of electrodes to generate a discharge;
a window configured of the transmissive optical device as claimed in claim 12, the window being arranged on an beam path of a laser beam and outside the pair of electrodes to receive the laser beam.

20. An amplifier stage laser device comprising:
a pair of electrodes to generate a discharge;
a window to receive a laser beam arranged on an beam path of the laser beam and outside the pair of the electrodes; and
an output coupler arranged on the beam path and outside the window,
wherein at least one of the window and the output coupler is configured of the transmissive optical device as claimed in claim 12.

21. An oscillation stage laser device comprising:
a pair of electrodes to generate a discharge;
a window to receive a laser beam arranged on an beam path of the laser beam and outside the pair of the electrodes;
an output coupler arranged on the beam path and outside the window; and
a prism arranged on the beam path and outside the window opposite to the output coupler,
wherein at least one of the window, the output coupler and the prism is configured of the transmissive optical device as claimed in claim 12.

22. A laser apparatus comprising:
a pair of electrodes to generate a discharge;
a window to receive a laser beam arranged on an beam path of the laser beam and outside the pair of the electrodes;
an output coupler arranged on the beam path and outside the window;
a prism arranged on the beam path and outside the window opposite to the output coupler; and
a beam splitter arranged on the beam path,
wherein at least one of the window, the output coupler, the prism and the beam splitter is configured of the transmissive optical device as claimed in claim 12.
